(19) United States
(12) Patent Application Publication
(10) Pub. No.: US 2015/0193028 A1
(43) Pub. Date: Jul. 9, 2015

(54) DISPLAY DEVICE AND METHOD OF ERASING INFORMATION INPUT WITH PEN

(71) Applicant: Panasonic Intellectual Property Management Co., Ltd., Osaka (JP)

(72) Inventor: Atsushi NARITA, Osaka (JP)

(21) Appl. No.: 14/666,676

(22) Filed: Mar. 24, 2015

Related U.S. Application Data
(63) Continuation of application No. PCT/JP2012/008081, filed on Dec. 18, 2012.

(30) Foreign Application Priority Data
Sep. 26, 2012 (JP) 2012-211843

(51) Int. Cl. G06F 3/0354; G06F 3/041

(52) U.S. Cl. CPC G06F 3/03545; G06F 3/0418; G06F 2203/04101

(57) ABSTRACT

A display device includes a display unit, a pen position acquiring unit that acquires a contact position of the electronic pen on the display unit, or a proximity position of the electronic pen on the display unit, a display controller that displays on the display unit a trace of contact positions, a touch sensing unit that senses a touch position on the display unit, and a controller that sets the acquired proximity position of the electronic pen as a reference position. In a case where the touch sensing unit senses the touch position, the controller performs a process of erasing a display presented by input with a pen, when the sensed touch position is within a predetermined range from the reference position, and executes a process different from the process of erasing a display, when the sensed touch position is outside the predetermined range.

### CROSS-REFERENCE TO RELATED APPLICATIONS

This is a continuation application of International Application No. PCT/JP2012/008081, with an international filing date of Dec. 18, 2012, which claims priority of Japanese Patent Application No.: 2012-211843 filed on Sep. 26, 2012, the contents of which are incorporated herein by reference.

### BACKGROUND

1. Technical Field

The present disclosure relates to a display device capable of inputting information with an electronic pen and/or a touch operation.

2. Related Art

The Japanese patent application publication JP2001-222378A discloses a touch panel input device. This touch panel input device includes layers A and B. The layer A includes a first transparent film, a first transparent resistive film, a second transparent resistive film, a second transparent film, and a first dot spacer. The layer B includes a second transparent film, a third transparent resistive film, a fourth transparent resistive film, a glass substrate, and a second dot spacer. This structure enables information of input position to be detected irrespective of whether the input is performed using a fingertip or a pen.

### SUMMARY

The present disclosure provides a display device capable of erasing a display provided by input operation with a pen, by a finger without performing other operations.

In one aspect, a display device is provided which includes a display unit configured to display information, a pen position acquiring unit configured to acquire a contact position on the display unit, with which an electronic pen comes into contact, or a proximity position on the display unit, to which the electronic pen comes close, a display controller configured to display on the display unit a trace of contact positions of the electronic pen acquired by the pen position acquiring unit, a touch sensing unit configured to sense a touch position on the display unit, which is touched by a user, and a controller. The controller sets the acquired proximity position of the electronic pen as a reference position, In a case where the touch sensing unit senses the touch position, the controller performs a process of erasing a display presented by input with a pen, when the sensed touch position is within a predetermined range from the reference position, and executes a process different from the process of erasing a display, when the sensed touch position is outside the predetermined range.

In a second aspect, a method for erasing a display which is presented, by input with a pen, on a display device is provided. The display device has a display unit for displaying information and is capable of receiving input with an electronic pen. The method includes

acquiring a contact position on the display unit, with which the electronic pen comes into contact or a proximity position on the display unit, to which the electronic pen comes close,

displaying a trace of acquired contact positions of the electronic pen on the display unit,

sensing a touch position on the display unit, based on a touch operation by a user,

setting the acquired proximity position of the electronic pen as a reference position and,

when the touch position of the touch operation by the user is sensed,

performing a process of erasing a display presented by input with a pen at the sensed touch position when the sensed touch position is within a predetermined range from the reference position,

executing a process different from the process of erasing a display when the sensed touch position is outside the predetermined range.

According to the present disclosure, there is provided a display device capable of erasing a display provided by input operation with a pen, by a finger without performing other operations, thereby improving user's convenience.

### BRIEF DESCRIPTION OF DRAWINGS

FIG. 1 is a diagram depicting a sectional configuration of a display device of a first embodiment;

FIG. 2 is a diagram depicting a configuration of an electronic pen of the first embodiment;

FIG. 3 is a flowchart for explaining an operation of the electronic pen of the first embodiment;

FIG. 4 is an explanatory view of an information input operation using the electronic pen on the display device;

FIG. 5 is an explanatory view of an operation of erasing information on the display device using a finger;

FIG. 6 is a flowchart for explaining an operation of the display device of the first embodiment;

FIG. 7 is an explanatory view of a positional relationship between the electronic pen and a finger in the erasing operation;

FIG. 8 is a flowchart for explaining an operation of a display device of a second embodiment; and

FIG. 9 is a flowchart for explaining an operation for determining a reference point of the display device of the second embodiment.

### DETAILED DESCRIPTION OF EMBODIMENTS

Embodiments will now be described in detail with proper reference to the drawings. Unnecessarily detailed description may however be omitted. For example, detailed description of well-known matters and repeated description of substantially the same configuration may be omitted. This is for the purpose of preventing the following description from becoming unnecessarily redundant to facilitate the understanding of those skilled in the art. The inventor provides the accompanying drawings and the following description so that those skilled in the art can fully understand this disclosure and do not intend to limit subject matters defined in the claims thereto.

A display device of embodiments which will be described below is electronic equipment capable of inputting information and being operated by a finger or an electronic pen. Examples of such electronic equipment include a smartphone, a tablet terminal, a notebook personal computer, and an electronic blackboard.

### First Embodiment

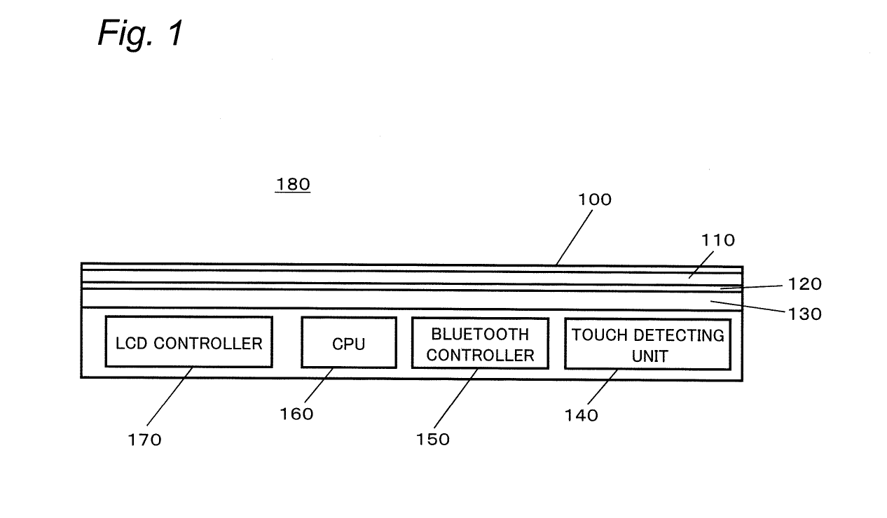

A first embodiment will be described below referring to FIGS. 1 to 7.

### 1-1. Configuration

### 1-1-1. Configuration of Display Device

FIG. 1 shows a sectional configuration of a display device of the first embodiment.

As described in FIG. 1, a display device 180 includes a dot-patterned film 100, a cover glass 110, a touch detecting sensor 120, a liquid crystal panel 130, a touch detecting unit 140, a Bluetooth controller 150, a CPU (Central Processing Unit) 160, and a liquid crystal display (LCD) controller 170.

The dot-patterned film 100 is a film mounted with dots in a specific arrangement so that an image processing unit (described later) of an electronic pen can specify an image position from a pattern of dots arranged within a predetermined range. The cover glass 110 is a glass for protecting the liquid crystal panel 130 and the touch detecting sensor 120. The touch detecting sensor 120 is mounted with transparent electrodes arranged in a lattice fashion, for example. The touch detecting sensor 120 monitors a change in voltage on the transparent electrode, or the like, to detect a contact of a finger, or the like.

The liquid crystal panel 130 displays a display pattern decided by the liquid crystal display controller 170. The liquid crystal panel 130 displays on the basis of the display pattern, videos, images such as various icons, and various information provided based on application, such as texts.

The touch detecting unit 140, for example, performs a voltage control for the touch detecting sensor 120 on the liquid crystal panel 130 and monitors a voltage change, or the like, to detect a contact of a finger, or the like, to the liquid crystal panel 130, thereby generating contact position information (coordinate data) on the liquid crystal panel 130. The touch detecting unit 140 does not detect a contact of the electronic pen of the present embodiment with the liquid crystal panel 130.

The Bluetooth controller 150 receives data sent from a Bluetooth controller (described later) of the electronic pen and transfers the received data to the CPU 160, the data including position information which the electronic pen contacts with or comes close to and contact information of a pen pressure sensor (described later).

The CPU 160 reads and executes a program stored in a storage unit (not shown) to control general operations of the display device 180. The CPU 160 acquires touch position information from the touch detecting unit 140 and acquires position information which the electronic pen contacts with or comes close to, from the Bluetooth controller 150. The CPU 160 notifies the liquid crystal display controller 170 of a trace of the acquired contact positions of the electronic pen to display the trace on the liquid crystal panel 130. From the acquired touch position information and the position information of the electronic pen, the CPU 160 decides whether to execute an erasing process or to execute another process in response to the touch operations, and notifies the liquid crystal display controller 70 of a display instruction based on the decision. On the basis of a detection signal from the touch detecting unit 140, the CPU 160 performs display control based on user's gesture operations such as flick, pinch-in, and pinch-out.

The liquid crystal display controller 170 generates a display pattern notified from the CPU 160 and displays it on the liquid crystal panel 130. The liquid crystal display controller 170 displays on the liquid crystal panel 130 the trace of contact positions of the electric pen acquired by the CPU 160.

### 1-1-2. Configuration of Electronic Pen

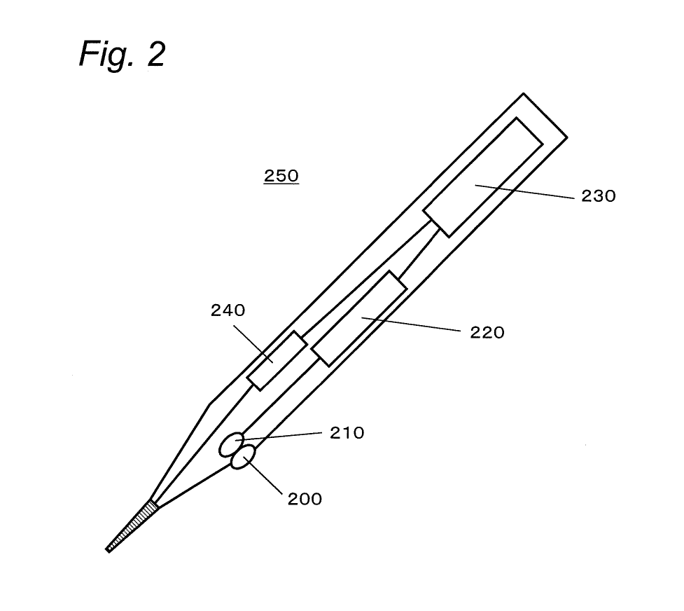

FIG. 2 is a diagram showing a configuration of the electronic pen of the first embodiment.

In FIG. 2, an electronic pen 250 includes an LED 200, an image sensor (camera) 210, an image processing unit 220, a Bluetooth controller 230, and a pen pressing sensor 240.

The LED emits light. Based on a reflected light of light emitted from the LED 200, the image sensor 210 reads a dot pattern of the film 100 located at a pen point when the electronic pen 250 comes into contact with the dot-patterned film 100, and then transfers image data including the read pattern to the image processing unit 220. The image sensor 210 can read a dot pattern lying ahead of the pen point of the electronic pen 250 as long as the electronic pen 250 comes close to the dot-patterned film 100, even though it is not in contact with the dot-patterned film 100.

The image processing unit 220 analyzes image data (a dot pattern) acquired from the image sensor 210 and generates position information (coordinate data) of contact position of the pen point to transfer the position information to the Bluetooth controller 230. When the electronic pen 250 comes close to the dot-patterned film 100 without contacting it and is held at a slant relative to the dot-patterned film 100, the image sensor 210 reads a dot pattern shifted from a foot of perpendicular from the pen point of the electronic pen 250 to the dot-patterned film 100. When the electronic pen 250 is held at a slant relative to the dot-patterned film 100 without contact therewith, the shape of the dot pattern acquired by the image sensor 210 varies depending on the slant of the electronic pen 250. For this reason, the image processing unit 220 calculates the slant of the electronic pen 250 from the variation of the shape to correct the position depending on the slant. As a result, there can be generated position information of a position of the foot of the perpendicular from the pen point of the electronic pen 250 to the dot-patterned film 100.

The Bluetooth controller 230 of the electronic pen 250 sends position information transferred from the image processing unit 220 and contact information transferred from the pen pressure sensor 240 to the Bluetooth controller 150 of the display device 180.

The pen pressure sensor 240 detects whether the pen point of the electronic pen 250 is in contact with another object and transfers contact information indicative of the detection result to the Bluetooth controller 230 of the electronic pen 250.

### 1-2. Operation

Operations of the display device 180 and electronic pen 250 configured as described above will be described below.

### 1-2-1. Operation of Electronic Pen

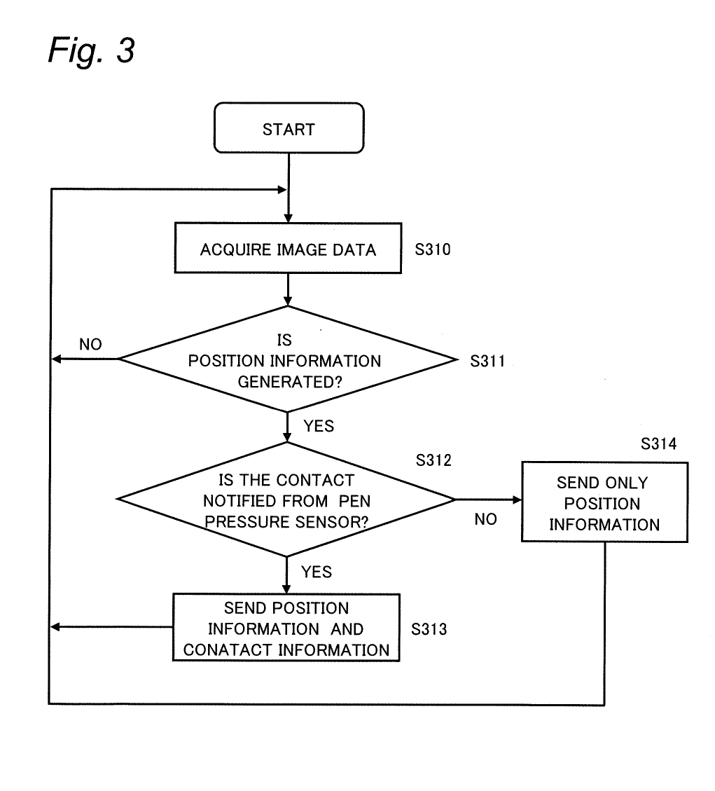

FIG. 3 is a flowchart of an operation of the electronic pen 250.

As shown in FIG. 3, the image sensor 210 of the electronic pen 250 transfers captured image data to the image processing unit 220 at any time (S310).

The image processing unit 220 analyzes a dot pattern from the acquired image data and generates position information (coordinate data) of the pen point contact position.

When the electronic pen 250 is not in contact with or not in the proximity of the dot-patterned film 100 so that the image sensor 210 cannot acquire a dot pattern, the image processing unit 220 does not generate position information (NO at S311). In this case (NO at S311), the procedure returns to step S310.

On the other hand, when the electronic pen 250 is in contact with or in the proximity of the dot-patterned film 100, the image processing unit 220 can analyze a dot pattern from image data. In this case, the image processing unit 220 generates position information to transfer the position information to the Bluetooth controller 230 (YES at S311).

When receiving position information from the image processing unit 220, the Bluetooth controller 230 determines whether contact information is notified from the pen pressure sensor 240 (S312).

When the electronic pen 250 is in contact with the surface of the display device 180, contact information is notified from the pen pressure sensor 240 to the Bluetooth controller 230 (YES at S312), which in turn sends contact information and position information to the Bluetooth controller 150 of the display device 180 (S313).

When the electronic pen 250 is not in contact with the surface of the display device 180 (NO at S312), that is, when contact information is not notified from the pen pressure sensor 240, the Bluetooth controller 230 sends only position information to the display device 180 (Bluetooth controller 150) (S314).

### 1-2-2 Input and Erasure of Information in Display Device

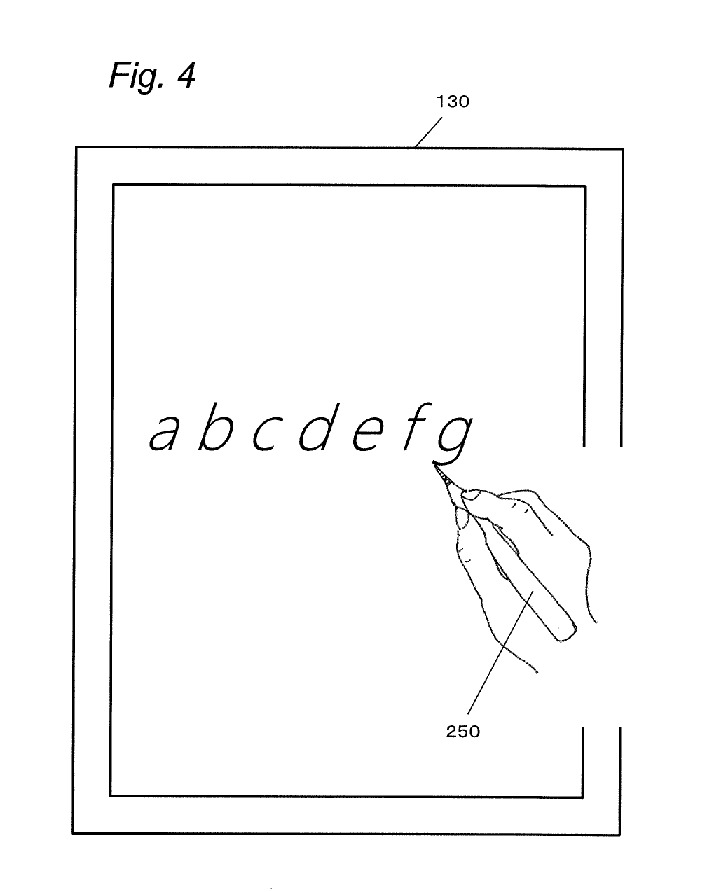

Information can be input to the display device 180 of the present embodiment using the electronic pen 250. Specifically, the CPU 160 grasps a position on the liquid crystal panel 130 on which information is input with the electronic pen 250 based on position information and contact information received from the electronic pen 250 by the Bluetooth controller 150, and controls the liquid crystal panel 130 to change a display presented at the position. For example, when the user moves the electronic pen 250 with the pen being in contact with the liquid crystal panel 130 of the display device 180 as shown in FIG. 4, a trace (“abcdefg”) of the movement is displayed on the liquid crystal panel 130. Thus, the user can input information to the display device 180 using the electronic pen 250.

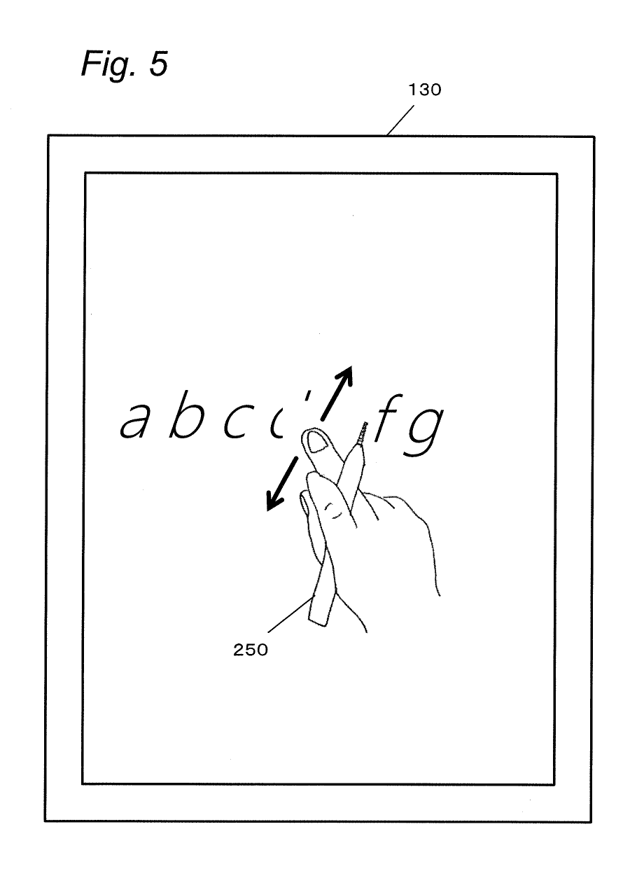

The display device 180 can erase information written by the electronic pen 250 with a touch of user's finger to the liquid crystal panel 130. Specifically, by moving a finger in contact with a region of the liquid crystal panel 130 in which information written by the electronic pen 250 is displayed, the user can erase the information (the details will be described later). For example, after writing “abcdefg” by use of the electronic pen 250 as shown in FIG. 4, the user can erase characters “d” and “e” by moving a finger on regions of “d” and “e” as shown in FIG. 5. If the user desires to erase information immediately after writing, the user may generally change a way to hold the electronic pen 250 and then perform the erasing action using a fingertip, with the electronic pen 250 held in hand, as shown in FIG. 5. The display device 180 therefore determines the presence or absence of the erasing action by the finger, based on the relationship between the position of a finger touching the liquid crystal panel 130 and the position of the pen point of the electronic pen 250 (the details will be described later).

As described above, the display device 180 of the present embodiment enables inputting of information using the electronic pen 250 and erasing of information using a finger.

### 1-2-3. Display Operation Based on Touch Operation in Display Device

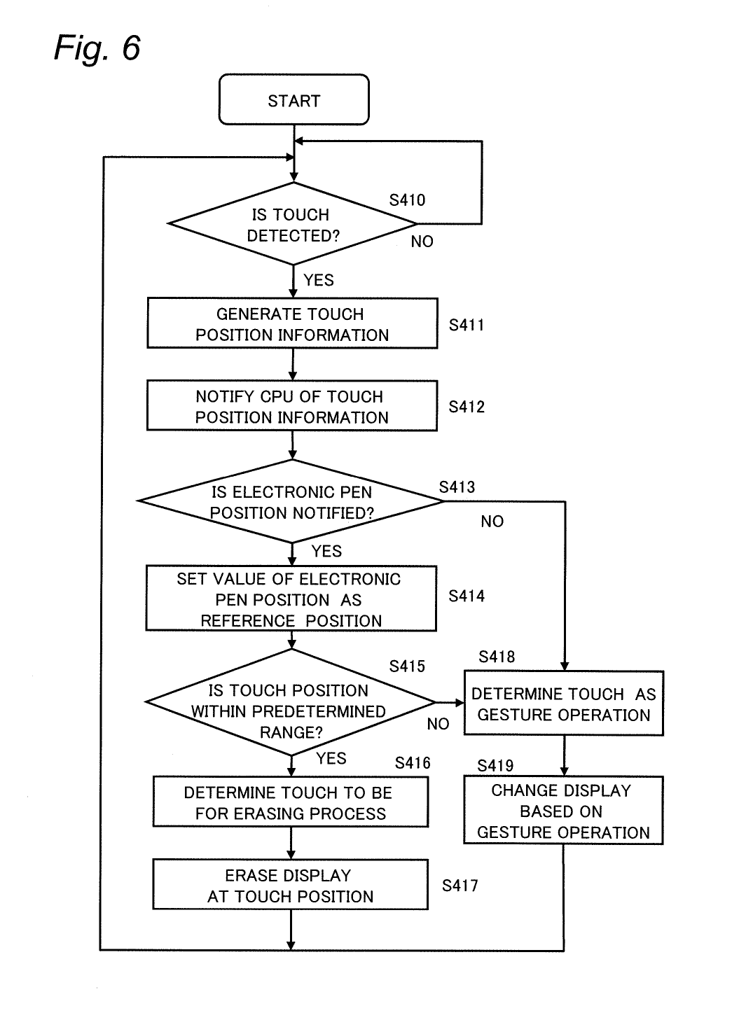

An operation of the display device 180 will be described below, which is performed when a touch operation is detected in the display device 180. FIG. 6 is a flowchart of operation of the display device 180 performed when a touch operation is detected in the display device 180.

During the operation of the flowchart shown in FIG. 6, when receiving position information and contact information from the electronic pen 250, the Bluetooth controller 150 of the display device 180 notifies the CPU 160 of the received information.

The touch detecting unit 140 of the display device 180 controls the touch detecting sensor 120 to always monitor a touch of a finger, or the like, with the liquid crystal panel 130 (S410). When detecting a touch (YES at S410), the touch detecting unit 140 generates touch position information (coordinate data) based on a signal from the touch detecting sensor 120 (S411) and notifies the CPU 160 the touch position information (S412).

When acquiring the touch position information from the touch detecting unit 140, the CPU 160 checks whether position information of the electronic pen 250 is notified from the Bluetooth controller 150 (S413).

When the position information of the electronic pen 250 is not notified from the Bluetooth controller 150 (NO at S413), the CPU 160 determines which gesture operation is performed among a plurality of ordinary gesture operations, using the touch position information notified from the touch detecting unit 140 and a series of touch position information notified so far, and notifies the liquid crystal display controller 170 of the determination result (S418). The ordinary gesture operations include, for example, operations such as flick, pinch-in, and pinch-out. The liquid crystal display controller 170 generates a display pattern based on the notified gesture operation and displays the display pattern on the liquid crystal panel 130 (S419).

On the other hand, when the position information of the electronic pen 250 is notified from the Bluetooth controller 150 when acquiring the touch position information from the touch detecting unit 140 (YES at S413), the CPU 160 sets position information of the electronic pen 250 to a reference position (S414). Information of the reference position is stored in a storage unit built in the CPU 160.

The CPU 160 then determines whether the position indicated by the touch position information notified from the touch detecting unit 140 lies within a predetermined range around the reference position (S415). The predetermined range is a range in a shape of a circle or a polygon (triangle, rectangle, or the like) around the reference position. The reason to determine whether the position indicated by the touch position information lies within the predetermined range around the reference position is described below.

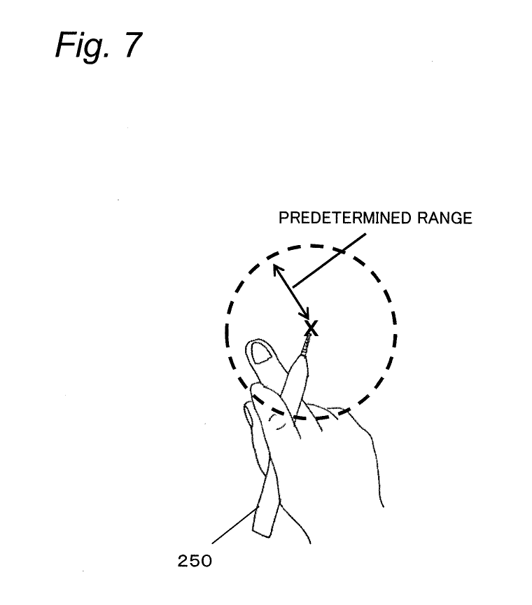

When erasing a display by moving a finger in contact with the liquid crystal panel with the electronic pen 250 held as shown in FIG. 5, it is deemed that the finger and the pen point of the electronic pen 250 are close to each other (see FIG. 7). Thus, in the present embodiment, it is determined whether the position (finger's contact position) indicated by the touch position information lies within the predetermined range around the reference position (position of the electronic pen 250), in order to determine whether the user performs an erasing action using a finger with the electronic pen 250 held as shown in FIG. 5.

When the touch position information does not lie within the predetermined range around the reference position (NO at S415), that is, when the erasing action is determined not to be performed, the CPU 160 determines which gesture operation is made using touch position information notified from the touch detecting unit 140 and a series of touch position information notified so far, and informs the liquid crystal display controller 170 of the determination result (S418). The liquid crystal display controller 170 generates a display pattern based on the notified gesture operation and displays the display pattern on the liquid crystal panel 130 (S419).

When the position indicated by the touch position information lies within the predetermined range around the reference position (YES at S415), the CPU 160 determines that the notified touch operation is to be done for an erasing process of a display presented by pen-input at the detected touch position (S416) and instructs the liquid crystal display controller 170 to erase the display at the touch position.

The liquid crystal display controller 170 instructed to erase the display at the touch position generates a display pattern in which the display presented by pen-input is erased based on the touch position information, and displays the display pattern on the liquid crystal panel 130 (S417).

### 1-3. Effect, Etc.

In the present embodiment, as described above, the display device 180 includes: the liquid crystal panel 130 configured to display information; the CPU 160 for acquiring a contact position on the liquid crystal panel 130, which the electronic pen 250 comes into contact with or a proximity position on the liquid crystal panel 130, which the electronic pen 250 comes close to; the liquid crystal display controller 170 configured to display on the liquid crystal panel 130 a trace of contact positions of the electronic pen 250 acquired by the CPU 160; and the touch detecting unit 140 configured to detect a touch position touched by the user on the liquid crystal panel 130. The CPU 160 sets the acquired proximity position of the electronic pen 250 as a reference position. When the touch operation is detected by the touch detecting unit 140, if the detected touch position is within a predetermined range from a reference position, the CPU 160 performs the process of erasing a display presented by input with the pen at the detected touch position. On the other hand, if the detected touch position is outside the predetermined range, the CPU 160 executes a process different from the process of erasing.

With the above arrangement, in erasing a trace (texts, etc.) after the trace (characters, etc.) is displayed on the liquid crystal panel 130 which is presented by input of characters, etc., with the electronic pen 250, the trace lying within the predetermined range from the position of the electronic pen 250 can be erased with a finger. This eliminates the necessity of performing a useless operation such as selecting, for example, an eraser icon for the erasing process. Outside the predetermined range around the position of the electronic pen 250, a finger-touch operation enables ordinary gesture operations, such as flick, pinch-in, and pinch-out for example.

### Second Embodiment

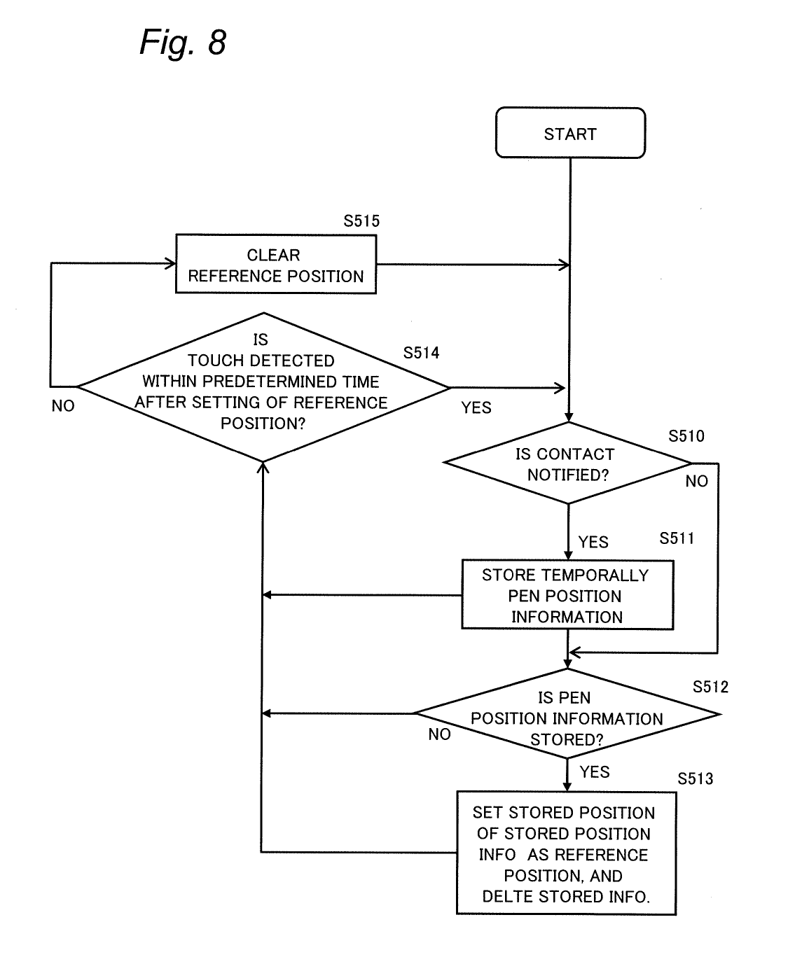

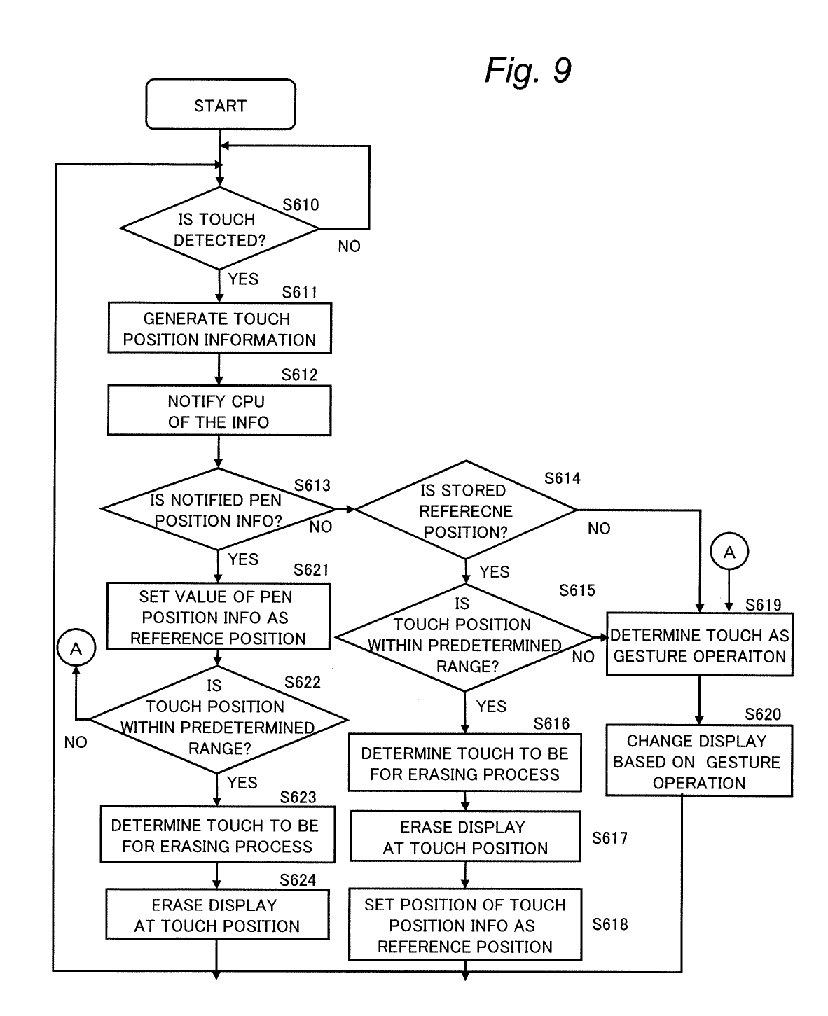

A second embodiment will be described below referring to FIGS. 8 and 9. In the first embodiment, in cases where the position information of the electronic pen 250 cannot be acquired when a touch operation is detected, the display device 180 determined that it is a gesture operation and performs a display control based on the gesture operation. On the contrary, the present embodiment describes a configuration which enables that when performing the erasing with a finger (touch operation), the erasing operation can be determined even if the position information of the electronic pen 250 cannot be acquired due to the status (slant, etc.) of the electronic pen 250, that is, even if the position information cannot be generated in the image processing unit 220 of the electronic pen 250.

### 2-1. Configuration

The configurations of the display device 180 and the electronic pen 250 in the second embodiment are the same as those in the first embodiment so that they will not again be described.

### 2-2. Operation

FIGS. 8 and 9 are flowcharts of processes performed by the display device 180 of the present embodiment. FIG. 8 is a flowchart of an operation of setting a reference position. FIG. 9 is a flowchart of display operation based on a touch operation on the liquid crystal panel 130. The reference position setting operation will first be described with reference to FIG. 8.

### 2-2-1 Reference Position Setting Operation

The CPU 160 checks whether position information of the electronic pen 250 is notified from the Bluetooth controller 150 and whether the notified information contains not only the position information of the electronic pen 250 but also contact information generated by the pen pressure sensor 240 (S510) When the position information of the electronic pen 250 is notified from the Bluetooth controller 150 and when the contact information is contained such as when inputting with the electronic pen 250 (YES at S510), the CPU 160 stores the notified position information of the electronic pen 250 together with the contact information in the CPU 160 (S511).

On the other hand, when the position information of the electronic pen 250 is not notified from the Bluetooth controller 150 or when the contact information is not notified but only the position information of the electronic pen 250 is notified (NO at S510), the CPU 160 checks whether position information of the electronic pen 250 is already stored in the CPU 160 (S512). When the position information is stored therein (YES at S512), the CPU sets a position indicated by the stored position information as a reference position and erases the stored position information (S513). When the position information is not stored in the CPU 160 (NO at S512), the CPU 160 does not perform setting of the reference position.

When a touch is not detected by the touch detecting unit 140 within a predetermined time after the last setting of the reference position (NO at S514), the CPU 160 clears the reference position stored in the interior of the CPU 160 (S515).

Through the above processes, a most recently acquired contact position of the electronic pen 250 (a position of the last contact of the electronic pen 250 on the screen) is set as the reference position.

### 2-2-2. Display Operation Based on Touch Operation

Referring to FIG. 9, an operation of the CPU 160 will be described in the case where the CPU 160 is not notified of position information of the electronic pen due to the status (slant, etc.) of the electronic pen 250 when touch position information is notified from the touch detecting unit 140.

Since processes of steps S610 to S612 of FIG. 9 are the same as those of steps S410 to S412 described in the first embodiment, description thereof will be omitted. Processes from step S613 will be described below.

After acquiring position information from the touch detecting unit 140, the CPU 160 determines whether position information is notified from the electronic pen 250 through the Bluetooth controller 150 (S613).

When the position information is not notified from the electronic pen 250 (NO at S613), the CPU 160 checks whether a reference position is already set (S614). When the reference position is not set (NO at S614), the CPU 160 determines which gesture operation the user performs, using touch position information notified from the touch detecting unit 140 and a series of touch position information notified so far (S619), and notifies the liquid crystal display controller 170 of the determination result. The liquid crystal display controller 170 generates a display pattern based on the notified gesture operation and displays the display pattern on the liquid crystal panel 130 (S620).

On the other hand, when the reference position is set (YES at S614), the CPU 160 determines whether a touch position indicated by the touch position information notified from the touch detecting unit 140 lies within the predetermined range around the reference position (S615). When the touch position does not lie within the predetermined range around the reference position (NO at S615), the CPU 160 performs the processes of steps S619 and S620.

When the touch position information lies within the predetermined range around the reference position (YES at S615), the CPU 160 determines that the notified touch operation is provided for an erasing process of a display presented by input with the pen (S616) and instructs the liquid crystal display controller 170 to erase the display at the touch position.

The liquid crystal display controller 170 instructed to erase the display at the touch position generates a display pattern in which the display presented by pen-input is erased, based on the touch position information, and displays the display pattern on the liquid crystal panel 130 (S617). The CPU 160 sets the touch position indicated by the touch position information as a new reference position (S618).

When at step S613, the position information of the electronic pen 250 is notified from the Bluetooth controller 150 (YES at S613), the CPU 160 performs the same processes (S621 to S624) as steps S414 to S417 of the first embodiment.

### 2-3. Effect, Etc.

As described above, In this embodiment, in the case where the CPU 160 cannot acquire the proximity position of the electronic pen 250 when the touch detecting unit 140 detects a touch operation, the CPU 160 sets a most recently acquired contact position as the reference position. When the detected touch position lies within the predetermined range from the reference position, then CPU 160 performs an erasing process to erase a display presented by input with the pen at the detected touch position. When the detected touch position lying outside the predetermined range, the CPU 160 executes another process (e.g., a process based on the gesture operation) different from the erasing process.

As a result, even though position information of the electronic pen 250 cannot be generated or acquired due to the status (slant, etc.) of the electronic pen 250 when performing an erasing operation with a finger, the finger-erasing operation becomes possible within the predetermined range around the reference position, by setting the position information at the time of the last (most recent) contact of the electronic pen 250 as a reference position.

Further, when the CPU 160 cannot acquire a proximity position of the electronic pen 250 when the touch detecting unit 140 detects a touch operation, the CPU 160 sets the most recently acquired contact position of the electronic pen 250 as a reference position. When the detected touch position is within the predetermined range from the reference position, the CPU 160 resets the detected touch position as a reference position.

With the above described arrangement, by setting the touch position of a finger indicated by the touch position information as a new reference position when performing an erasing operation with the finger, the erasing operation becomes possible at all times within a predetermined range around the finger's touch position without being limited to the predetermined range around the position of the last contact of the electronic pen 250.

### Other Embodiments

The first and the second embodiments have hereinabove been described as exemplary techniques disclosed in the present application. The techniques of this disclosure, however, are not limited thereto and are applicable to properly modified, replaced, added, or omitted embodiments. The components described in the first and the second embodiments may be combined as a new embodiment. Other embodiments will thus be exemplified below.

In the first and the second embodiments, the liquid crystal panel 130 is described as an example of a display unit. The display unit may be any unit that displays information. Accordingly, the display unit is not limited to the liquid crystal panel 130. It is however to be noted that use of the liquid crystal panel 130 as the display unit enables variously sized panels to be obtained at low cost. An organic EL (Electro-Luminescence) panel or a plasma panel may be used as the display unit.

In the first and the second embodiments, the touch detecting unit 140 is described as an example of a touch position sensing unit, which performs voltage control for the touch detecting sensor 120 on the liquid crystal panel 130 and monitors a change in voltage, or the like, and detects a touch of a finger, for example. The touch position sensing unit may be any sensing unit that senses a position on the display unit touched by a user. Accordingly, the touch position sensing unit is not limited to the above system. The system for detecting a touch position on the display unit may be a surface acoustic wave system in which a piezoelectric element is provided to generate oscillatory waves, an infrared-ray system which detects a position by interruption of infrared light, or an electrostatic capacity system which detects a position by sensing a change in electrostatic capacity of a fingertip.

In the first and the second embodiments, a system is described, as an example of the electronic pen, which reads with the image sensor 210 a dot pattern from the dot-patterned film 100 on which dots are arranged in a specific layout so that image position can be uniquely identified from the dot pattern in the predetermined range, and analyzes the read dot pattern to generate position information (coordinate data). The electronic pen may be any pen which can convert contents handwritten on the display unit by the user into data and enables the data to be displayed on the display unit. Therefore, the electronic pen is not limited to the above system. The system of the electronic pen may be an electro-magnetic induction system which receives an induction signal generated by moving the electronic pen on a magnetic field over the surface of the display unit to grasp a trace of the electronic pen, an infrared-ray/ultrasonic-wave system in which a sensor of the display unit senses infrared rays or ultrasonic waves emitted from the electronic pen, an optical system which grasps a trace of the electronic pen from shielded light on optical sensors of the display unit, or an electrostatic capacity system which detects a position based on a difference in electrostatic capacity arising from a press on the display unit. Further, the system of the electronic pen may be a system which grasps position information utilizing a plasma light-emitting principle.

In the first and the second embodiments, the system is described in which the Bluetooth controller 150 of the display unit 180 and the Bluetooth controller 230 of the electronic pen 250 communicate with each other through Bluetooth. The electronic pen 250 may be any pen which can send data, such as position information at the time of coming into contact or coming close to the display unit or contact information of the pen pressure sensor 240, to the display device 180. Accordingly, the communication interface is not limited to Bluetooth. The communication interface may be a wireless LAN, a wired USB (Universal Serial Bus), or a wired LAN. Furthermore, in the case where the display device 180 can detect position information of the electronic pen 250 contact or close to the display unit, depending on the system of the electronic pen, communication need not be made between the display device 180 and the electronic pen 250.

In the first and the second embodiments, when the CPU 160 determines whether the position indicated by the touch position information notified from the touch detecting unit 140 lies within a predetermined range around a reference position, the predetermined range is stored in advance on the storage unit (not shown). However, the predetermined range may be set by the user. This enables proper setting of a desired range of an erasing process which is individually different depending on a way to hold the electronic pen by each of users.

In the second embodiment, if the proximity position of the electronic pen 250 cannot be acquired, the most recently acquired contact position of the electronic pen 250 is set as the reference position. However, even when the proximity position of the electronic pen 250 can be acquired, the most recently acquired contact position may be set as the reference position. This can reduce burdens in the process of acquiring the proximity position of the electronic pen 250 and processes of the CPU 160.

The aforementioned embodiments are described as examples of the techniques in the present disclosure. To this end, the accompanying drawings and the detailed description are provided.

Hence, the components described in the accompanying drawings and the detailed description may encompass not only components essential to the solution of the problems but also components unessential to the solution of the problems, for the exemplification of the above techniques. Accordingly, those unessential components are not to be construed to be essential immediately from the fact that those unessential components are described in the accompanying drawings and the detailed description.

The above embodiments are provided merely for the purpose of exemplifying the techniques in the present disclosure, and thus the embodiments can variously be modified, replaced, added, or omitted without departing from the claims and scopes equivalent thereto.

### INDUSTRIAL APPLICABILITY

The present disclosure is applicable to electronic equipment capable of inputting information with a pen or a finger. For example, the present disclosure is applicable to equipment such as a smartphone, a tablet, and an electronic blackboard.

1. A display device comprising:
a display unit configured to display information;
a pen position acquiring unit configured to acquire a contact position on the display unit, with which an electronic pen comes into contact, or a proximity position on the display unit, to which the electronic pen comes close;
a display controller configured to display on the display unit a trace of contact positions of the electronic pen acquired by the pen position acquiring unit;
a touch sensing unit configured to sense a touch position on the display unit, which is touched by a user; and
a controller, wherein
the controller sets the acquired proximity position of the electronic pen as a reference position,
in a case where the touch sensing unit senses the touch position, the controller
performs a process of erasing a display presented by input with a pen, when the sensed touch position is within a predetermined range from the reference position, and
executes a process different from the process of erasing a display, when the sensed touch position is outside the predetermined range.

2. The display device according to claim 1, wherein
when the controller cannot acquire the proximity position of the electronic pen in a case where the touch position sensing unit senses a touch position, the controller sets a most recently acquired contact position of the electronic pen as the reference position, and then
the controller performs a process of erasing a display presented by input with a pen at the sensed touch position, when the sensed touch position is within the predetermined range from the reference position, and
executes a process different from the process of erasing a display, when the sensed touch position is outside the predetermined range.

3. The display device according to claim 2, wherein
when the controller cannot acquire the proximity position of the electronic pen in a case where the touch position sensing unit senses a touch position, the controller sets a most recently acquired contact position of the electronic pen as the reference position, and resets the sensed touch position as the reference position when the sensed touch position is within the predetermined range from the reference position.

4. A method for erasing a display which is presented, by input with a pen, on a display device, the display device having a display unit for displaying information and capable of receiving input with an electronic pen, the method comprising:
acquiring a contact position on the display unit, with which the electronic pen comes into contact or a proximity position on the display unit, to which the electronic pen comes close;
displaying a trace of acquired contact positions of the electronic pen on the display unit;
sensing a touch position on the display unit, based on a touch operation by a user;
setting the acquired proximity position of the electronic pen as a reference position and,
when the touch position of the touch operation by the user is sensed,
performing a process of erasing a display presented by input with a pen at the sensed touch position when the sensed touch position is within a predetermined range from the reference position,
executing a process different from the process of erasing a display when the sensed touch position is outside the predetermined range.
